(19) United States
(12) Patent Application Publication
(10) Pub. No.: US 2006/0091121 A1
(43) Pub. Date: May 4, 2006

(54) Method for reflowing a metal plating layer of a contact and contact formed thereby

(76) Inventors: James Zanolli, North Smithfield, RI (US); Jack Seidler, Flushing, NY (US); Joseph Cachina, Warwick, RI (US)

Correspondence Address: DARBY & DARBY P.C., P. O. BOX 5257, NEW YORK, NY, 10150-5257, US

(21) Appl. No.: 11/234,857

(22) Filed: Sep. 22, 2005

Related U.S. Application Data
(60) Provisional application No. 60/616,499, filed on Oct. 6, 2004.

(51) Int. Cl. B23K 26/00; B23K 26/16; C25D 5/00

(52) U.S. Cl. 219/121.67; 205/80; 219/121.6; 219/121.65

(57) ABSTRACT

According to one aspect of the present invention, a method of reflowing a metal plated target area of a conductive contact is provided and includes the steps of: (1) providing a localized heat source, such as a laser; (2) positioning the contact relative to the localized heat source such that energy emitted by the localized heat source is focused on the plated target area of the conductive contact; and (3) operating the localized heat source and focusing the concentrated energy on the target area such that the metal plating in the target area is heated to a reflow temperature which is greater than a melting temperature of the metal plating so as to cause reflow of the metal plating. The use of the localized heat source (e.g., a laser) permits the reflow to be confined to the target area, while one or more adjacent areas are shielded from being heated to the reflow temperature. This procedure is particularly suited for use with pure tin platings where the reflow operation mitigates or eliminates the formation of tin whiskers, while at the same time, preserves the material properties, such as material spring properties, of the adjacent areas, as a result of shielding these areas from the reflow temperatures.

### CROSS REFERENCE TO RELATED APPLICATION

This application claims the benefit of U.S. Provisional Patent Application No. 60/616,499, filed Oct. 6, 2004, which is hereby incorporated by reference in its entirety.

### TECHNICAL FIELD

The present invention relates to the field of devices for joining electrical components to one another and, more particularly, to a metal plated electrical contact to establish an electrical connection between a first electronic device, such as a printed circuit board or connector, and a second electronic device, such as a printed circuit board and to a method of reflowing a plated section of the contact.

### BACKGROUND

It is often necessary and desirable to electrically connect one component to another component. For example, a multi-terminal component, such as a connector, is often electrically connected to a substrate, such as a printed circuit board, so that the contacts or terminals of the component are securely attached to contact pads formed on the substrate and/or to holes lined with an electroplating material in the substrate to provide an electrical connection therebetween. One preferred technique for securely attaching the component terminals to the contact pads and/or plated through holes is to use a solder material. In this application and in other applications, the electrical connection is typically made by means of a contact that is formed of a conductive material and plated with a conductive material that bonds with the solder material.

Contacts can be produced in any number of different ways from a number of different conductive materials and can come in any number of different shapes and sizes. For example, contacts are typically formed as a result of a stamping process or the like where a plurality of contacts are formed from a metal sheet. One common type of contact that has found widespread use is a contact that is formed of a copper alloy and plated with a tin (Sn)/lead (Pb) alloy.

However, there have been recent regulations introduced across the world as well as a widespread drive or interest to eliminate lead from electronics. This has sparked an interest in the electronics industry in using pure tin finishes as an economical lead-free (Pb free) plating option. However with the new found interest and emergence of tin plating relative to electrical contacts, there has been renewed concern over a phenomenon that is associated with tin plating, namely, the threat of failure due to tin whiskering. The phenomenon of tin whiskering is not new but rather has been reported for a number of years dating back to the 1940s when published reports indicated that tin, as well as several other metals, including Indium and Antimony, were observed to be capable of growing whiskers.

Tin whiskers are electrically conductive, crystalline structures of tin that sometimes grow from surfaces where tin is used as a final finish. Whiskers have been reported to grow to more than 10 mm in length and from 0.3 to 10 μm in diameter; although, they typically have a length of 1 mm or less and a diameter between 1 μm and 3 μm. The exact mechanism for whisker growth is not completely understood; however, it is generally accepted that the whiskers grow spontaneous without an applied field or moisture and grow independent of atmospheric pressure. The growth of whiskers may initiate right after plating of the metal; however, the growth might not initiate for a number of years after plating.

Tin whiskers pose a serious reliability risk to electronic assemblies that have components, such as contacts, that incorporate pure tin plating. The general risks that are associated with tin whiskers are the following: (1) stable short circuits in low voltage, high impedance circuits; (2) transient short circuits; (3) metal vapor arcing (plasma) in vacuum; and debris/contamination in that whiskers or parts of whiskers may break loose and bridge isolated conductors remote from the original site of whisker growth.

While the best strategy to avoid tin whisker induced failure of electronic hardware is to avoid using pure tin plating on any of the electronic parts, this might not be an especially attractive option in view of the growing interest and in some cases mandate to eliminate. It is generally considered that alloys of tin and lead are acceptable where the alloy contains a minimum of 3% lead by weight; however, these alloys still contain lead which is contrary to the recent regulations and interest in eliminating lead completely.

One of the mechanisms that has been discussed as a strategy to mitigate the presence and growth of tin whiskers is the reflow of pure tin plated surfaces. The melting point of tin is approximately 232° C. By reflowing or “fusing” pure tin plating, it is possible to reduce whisker formation. However, there are a number of undesirable consequences that result from undertaking such a task. First, the reflow process may damage temperature sensitive devices. In addition, the reflow of pure tin plated surfaces was conventionally done on unstamped material materials as opposed to stamped metal components, such as electronic contacts, by placing the pure tin plated component in an oven or the like. Stamped electronic contacts often have uneven shapes and this leads to uneven heat absorption when it is subjected to the elevated temperatures necessary to reflow the pure tin. This can directly lead to a contact that has an uneven distribution of pure tin plating in that, during the reflow process, the tin can migrate away from one location, thereby leaving a bare spot or thin layer of tin plating, to another location where excess tin plating is present and/or it is an area where no tin plating is desired. This is true not only for tin plating but also for other metal platings. In addition, in contacts that have other conductive areas formed of other metals, such as gold or other precious metals, subjecting these contacts to reflow temperatures can cause oxidation of these other metals (which is not desirable). In addition, conventional reflow processes can cause properties of the metal or contacts themselves to change.

Thus, it is desirable to provide an improved method of producing contacts that are formed of a conductive metal, besides lead, and do not suffer from the above disadvantages and thus can be used in the electronics industry.

### SUMMARY

According to one aspect of the present invention, a method of reflowing a metal plated target area of a conductive contact is provided and includes the steps of: (1) providing a localized heat source, such as a laser; (2) positioning the contact relative to the localized heat source such that energy (e.g., light energy) produced or emitted by the localized heat source is focused on the target area that represents a metal plated section of the conductive contact; and (3) operating the localized heat source and focusing the emitted energy on the target area such that the metal plating in the target area is heated to a reflow temperature which is greater than a melting temperature of the metal plating so as to cause reflow of the metal plating. The use of a localized heat source permits the reflow to be confined to the target area, while adjacent areas are shielded from exposure to the reflow temperature. This procedure is particularly suited for use with pure tin platings where the reflow operation mitigates or eliminates the formation of tin whiskers, while at the same time, preserves the material properties, such as, material spring properties, of the adjacent areas, as a result of shielding these areas from the reflow temperatures.

The use of a localized heat source that provides focused energy to cause heating of a target surface offers much better control over the reflow operation since a selective area, such as the solder tail or the like, can be targeted and heated to reflow temperatures; while adjacent body areas of the contact are not heated to reflow temperatures. This selectivity provides the following advantages. First, the reflow of the metal plated area (e.g., tin plated) advantageously mitigates or eliminates undesirable structural phenomena, such as whisker formation, as well as relieving any present undesirable organic compounds. More specifically, it has been found that undesirable organic compounds, such as occluded carbon, are relieved by the reflow process. Second, the use and precision control capability of a laser permits areas around the target area to be effectively shielded from reflow temperatures which can cause an undesirable change in material properties if these areas are exposed to such temperatures. This results from the ability to locally target very specific areas. For example, adjacent areas to the target areas should not be exposed to the elevated reflow temperatures since this can cause undesirable material changes, such as altering the spring properties of the material, e.g., an increase or decrease in the material spring properties can result, both of which are not desirable. Third, exposing other sections to the elevated reflow temperatures can cause oxidation to occur in these areas, which is not desirable; and therefore, by shielding these areas and not exposing them to the reflow temperatures, this occurrence is avoided. Fourth, the precision control and reflow abilities of the localized heat source permit only the target areas to reflow and in addition, the reflow itself is contained within the target areas. In other words, the energy and focusing characteristics of the localized energy source cause reflow of the plated material but do not cause migration of the reflow outside of the target area, i.e., no migration of the reflow to the adjacent areas. Fifth, reflow of the plated material can result in improved solderability of the contact.

Suitable localized energy sources include but are not limited to a laser, focused IR, xenon light (foucsed UV) or any other type of apparatus that can produce a focused source of energy that can be directed on a target area without adversely impacting and heating adjacent areas.

Other features and advantages of the present invention will be apparent from the following detailed description when read in conjunction with the accompanying drawings.

### BRIEF DESCRIPTION OF THE DRAWING

The foregoing and other features of the present invention will be more readily apparent from the following detailed description and drawings figures of illustrative embodiments of the invention in which:

FIG. 1 is a side elevation view of a conductive contact for use in electrical applications; and

FIG. 2 is a perspective view of a localized heat source used for reflowing a plating material that is part of the conductive contact.

### DETAILED DESCRIPTION OF PREFERRED EMBODIMENT

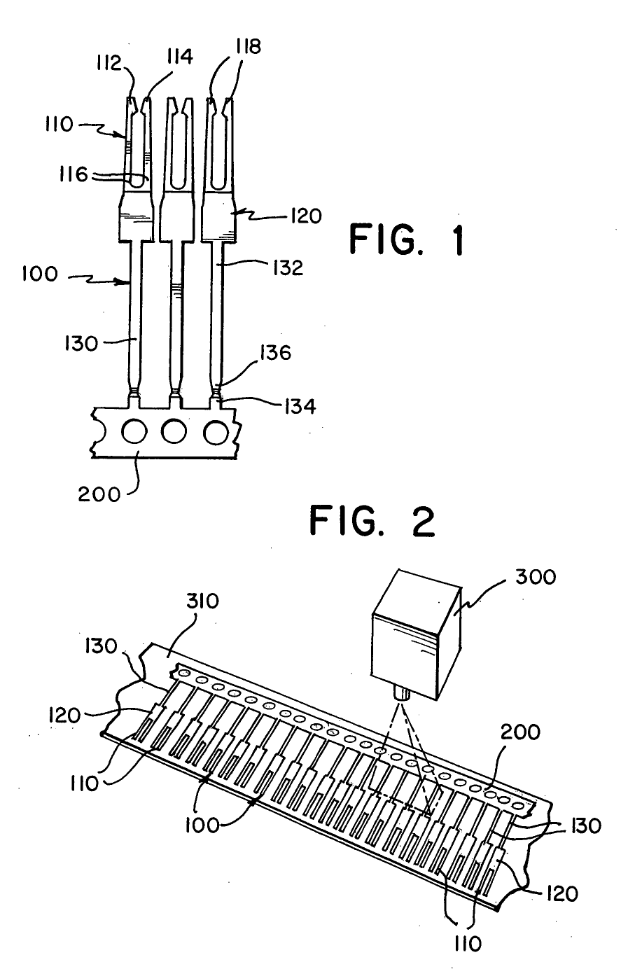

FIG. 1 is a side elevation view of a solder-bearing article in the form of a solder-bearing lead or contact for use in electrical applications. In particular, FIG. 1 shows a series of individual leads or contacts 100 that can initially be detachably connected to one another prior to their intended use or they can remain attached to one another during their intended use. The lead/contact 100 can be formed by any number of conventional techniques, including forming the contact 100 by stamping from a base material, such as a conductive strip (e.g., beryllium copper or like resilient and conductive material). As previously mentioned, it is commonplace for the stamped contacts 100 to be plated in one or more areas with a conductive material, such as a pure metal or an alloy, as a result of an electroplating operation. For example, one conductive plating metal that is used in place of lead or a tin/lead alloy is pure tin; however, other conductive plating materials can be used.

FIG. 1 illustrates one exemplary type of contact 100 and more specifically, the contact 100 is a of type that is commonly know as a “solder tail” contact due to its construction and shape. The contact 100 is defined by distinct sections, namely, a first section 110 that mates with a conductive element of an electronic component to establish an electrical connection therebetween; a second section 120 that is an intermediate section and represents a body section for the first section 110; and a third section 130 that is in the form of a solder tail. Typically, the contact 100, and more particularly, the solder tail 130 thereof, is detachably connected to a carrier strip 200 so as permit one contact 100 to be detached and separated from the carrier strip 200. When the contacts 100 are connected to the carrier strip 200, the bodies or bases 120 of individual contacts 100 are separated from each other so that all that is needed to separate the contacts from one another and from the carrier strip 200 is to detach the solder tail 130 from the carrier strip 200.

It will further be appreciated that a contact, such as contact 100, can have different sections that are formed of different materials and therefore, these different sections can have different specific material properties that require different handling. For example, in the illustrated contact 100, the first section 110 that serves as a mating area is typically formed of a first conductive material and requires very specific material properties, e.g., material spring properties that require a certain degree of handling; while, the solder tail 130 is plated with a second conductive material that has different material properties. More specifically, the first section 110 is often times formed of a conductive material, such as gold or another precious metal that will oxidize if exposed to heat for a period of time and therefore, this first section 110 should not be heated during a manufacturing process or during a given application. In order to satisfactorily serve as a conductive mating area that engages a conductive surface of an electronic component, the first section 110 has specific material spring properties. Conversely, the solder tail 130 is typically the section that includes a metal plating. In other words, the contact 100 has different, distinct plated sections that can be plated with different plating materials. Thus, the contact has a single underlying base material and the platings are plated on top of the underlying base material.

In the illustrated embodiment, the first section 110 is formed of a pair of opposing flexible contact fingers 112, 114 that are constructed and configured to receive a conductive element, such as a contact plate or the like, that is associated with a first electronic component. In order to provide a secure electrical connection between the first electronic component and the contact 100, the conductive element is inserted and securely held between the biased contact fingers 112, 114. The proximal ends 116 of the fingers 112, 114 are integrally connected to the contact body 120, with distal ends 118 being ends that engage and biasedly hold and retain the conductive element.

The solder tail 130 is as the term implies an elongated structure that extends outwardly from the body or base 120. The solder rail 130 has a proximal end 132 that is integrally attached to the body 120 at a surface or face that is opposite the one to which the fingers 112, 114 are attached. The solder tail 130 has a distal end 134 that is detachably connected to the carrier strip 200. The point of connection between the distal end 134 and the carrier strip 200 is preferably at a weakened section 136. The weakened section 136 can be an area of reduced diameter such that the solder tail 130 can be easily separated and broken away from the carrier strip 200 by bending or otherwise manipulating the contact 100 (solder tail 130) about the weakened section 136.

The contact 100 is formed of suitable conductive material and has a thickness that can vary depending upon the application.

According to one exemplary embodiment, the solder tail 130 is a metal plated structure and more particularly, a conductive material, e.g., a metal, is plated onto an underlying base element, using conventional plating techniques, such as an electroplating technique. For example, the conducting plating layer can be formed of a metal that is suitable for use in the intended application and according to one embodiment; the plating layer is a pure tin plating layer. As previously mentioned, there is an increased desire and need to eliminate the use of lead in electronic components and to develop suitable lead free (Pb free) alternatives. While a pure tin plating has a number of advantages, it does suffer from the above-described tin whisker phenomenon which provides undesirable and unacceptable results in electronic applications.

As a result of the desire to use a metal plating layer, e.g., pure tin, on only the solder tail 130 section, it is desirable to undertake a mitigation strategy, to reduce the chance of whiskers or other undesirable conditions. As previously mentioned, one mitigation strategy is to reflow the metal plating; however, the differences in material properties between the first section 110 and the solder tail 130 and the uneven shape of the contact 100 make this very difficult if conventional techniques, such as placing the contact 100 in an oven or exposing the entire contact 100 to a heat source, are used since there likely will be uneven heat absorption which will result in uneven reflow. For example, during a conventional reflow operation, the metal plating often reflows away from areas where it is desired that the plating remains, e.g., the solder tail 130, thereby potentially leaving “bare” spots and likewise, the metal plating can reflow to areas where it is not desired for there to be any metal plating, e.g., the first section 110 (resulting in pooling of the metal plating in undesirable areas). Thus, the shapes of the contacts 100 significantly limit the effectiveness of the traditional convection oven reflow technique as well as other similar reflow techniques, such as an infrared reflow technique.

In accordance with the present invention, an improved contact 100 is provided that has a more uniform metal plating layer in discrete, desired sections, as well as a method of reflowing the metal plating. It will be understood that while the present invention will be discussed in terms of the solder tail type contact 100, shown in FIG. 1, the teachings and reflow method disclosed herein are equally applicable to any number of other types of contacts and therefore, the present invention is not limited to being used only with a solder tail type contact for this is merely one exemplary type of contact.

Referring to FIGS. 1 and 2, more specifically, the present invention provides a technique for reflowing a metal plating area of a contact that overcomes the above noted disadvantages associated with the prior art due to the precise reflow control and ability to target select areas of the contact to expose to reflow conditions. In accordance with the present invention and in contrast to the conventional reflow apparatus of the prior art, the present invention uses a localized heat source 300 that is capable of emitting or generating focused (concentrated) energy (e.g., light energy, such as a light beam, column, etc.) that can be directed at and focused on selective areas to be heated to reflow temperatures, while at the same time, other areas are shielded from reflow temperatures. There are a number of different types of localized heat sources 300 that are suitable for use in the present invention so long as the localized heat sources 300 are capable of emitting or generating localized, focused energy that can be directed at a particular target as opposed to exposing the entire contact 100 to scattered, diffused or widespread energy or heat (e.g., hot air). For example, localized heat sources include but are not limited to lasers, focused IR heat source, and a xenon light (UV) heat source, etc. When a laser is the localized heat source 300, any number of different types of lasers are suitable for the intended application of applying energy to select, discrete areas to cause the temperature of the metal plating to be elevated to a temperature greater than its melting point, thereby causing reflow of the metal plating. For example, suitable lasers include but are not limited to: a diode laser, a CO₂ laser, YAG laser and a pulsed YAG laser.

FIG. 2 also illustrates a transporter or drive member 310 for delivering and removing the contacts 100 relative to the localized heat source 300. For example, an automated system can be constructed, with the drive member 310 serving to transport one or more and preferably an attached array of contacts 100 both from an to the localized heat source 300. The drive member 310, e.g., a conveyor belt, is orientated relative to the localized heat source 300 such that the concentrated energy is directed at the target area of the contacts 100. In other words, a bandoliered group of contacts 100 can be continuously fed to a station that contains the localized heat source 300 so as to pass the target area of the contacts 300 within the concentrated energy, while the non-target areas are shielded from such exposure.

Because of the way the localized heat source 300 generates concentrated, focused energy and the way energy can be emitted (e.g., short energy bursts), the inventors have discovered that the reflow of the metal plating can be controlled with increased precision, thereby eliminating or greatly diminishing the likelihood that the metal plating will reflow to an undesired location, e.g., a location other than the solder tail 130, of the contact 100. It will be appreciated that the same applies for each of the above mentioned localized heat sources 300 in that the localized heat sources provide focused energy (light energy, etc.) that is directed at very specific local areas of the contact (i.e., target areas).

For purpose of illustration only, the reflow process will be described below in terms of the localized heat source being a laser; however, it will be understood that this is merely one exemplary application and that other localized heat sources 300 can equally be used in the same manner as that described below. Thus, the following discussion is merely exemplary and not limiting.

To reflow the metal plating in one or more selective areas, e.g., the solder tail 130, of the contact 100, the laser is positioned proximate the contact 100 and is directed at one of the selective areas and then is operated according to standard operating procedures and protocol. It is important that the laser that is used be selected such that the concentrated energy emitted by the laser will cause the metal plating to heat to a temperature above the melting temperature of the metal plating, which is likewise a temperature at which reflow or “fusing” of the metal plating will occur; while at the same time, the material properties of the metal plating and/or adjacent surrounding areas of the contact 100 are not undesirably influenced or changed.

For example and according to one application, the laser 300 is positioned and operated relative to the contact 100 such that the tin plated solder tail 130 is exposed to the concentrated, focused energy of the laser and is reflowed only within the confines of the solder tail 130 itself. In the case of a pure tin plated solder tail 130, the reflow temperature is greater than approximately 232° C., which is the melting point of tin, and preferably, is within a temperature range that is elevated compared to the melting temperature of tin. For example, the tin plating can be heated to a temperature that is 50-80° C., above the melting point of tin. In other words, the laser is operated to heat the tin plated solder tail 130 to temperatures on the order of about 282-312° C., for a sufficient time to cause reflow of the material. It will be appreciated that this is merely one exemplary range and reflow can occur at temperatures outside of this range. Thus, broadly speaking, the laser is of a type and is operated so that the temperature of the tin plated area is heated to a temperature above the melting point of tin and to a temperature where reflow can occur and provide the desired reflow properties to the selective area.

The present inventors have discovered that the use of a laser 300 offers much better control over the reflow operation since a selective area, such as the solder tail 130, can be targeted and heated to reflow temperatures; while adjacent areas, such as body 120 and first section 110 are not heated to reflow temperatures. This selectivity provides the following advantages. First, the reflow of the metal plated area (e.g., tin plated) advantageously mitigates or eliminates undesirable structural phenomena, such as whisker formation, as well as relieving any present undesirable organic compounds. More specifically, it has been found that undesirable organic compounds, such as occluded carbon, are relieved by the reflow process. Second, the use and precision control capability of a laser 300 permits areas around the target area to be effectively shielded from reflow temperatures which can cause an undesirable change in material properties if these areas are exposed to such temperatures. This results from the ability to locally target very specific areas. For example, adjacent areas to the target areas should not be exposed to the elevated reflow temperatures since this can cause undesirable material changes, such as altering the spring properties of the material, e.g., an increase or decrease in the material spring properties can result, both of which are not desirable. Third, exposing other sections to the elevated reflow temperatures can cause oxidation to occur in these areas, which is not desirable; and therefore, by shielding these areas and not exposing them to the reflow temperatures, this occurrence is avoided. Fourth, the precision control and reflow abilities of the laser permit only the target areas to reflow and in addition, the reflow itself is contained within the target areas. In other words, the energy and focusing characteristics of the laser cause reflow of the plated material but do not cause migration of the reflow outside of the target area, i.e., no migration of the reflow to the first section 110 and body 120. Fifth, reflow of the plated material can result in improved solderability of the contact.

Once again, the present invention is directed, according to one embodiment, to the use of a laser 300 to reflow selective plated areas of a contact and while, a pure tin plating is one common and exemplary plating, the present invention is not limited to tin platings but can be practiced with other platings, including those made of alloys. It will be understood that the laser is therefore selected in view of the temperature range that is required to reflow the plated material (reflow temperatures). For example, different plated materials will have different melting temperatures and therefore, different reflow temperatures and therefore, there may by some fine tuning done to the laser to optimize the emitted energy to cause proper reflow temperatures.

In yet another aspect of the present invention, the localized heat source 300 is preferably of the type that can generate short, pulsed bursts of energy that are directed at the target area. The present applicants have discovered that the emission of short, pulsed bursts of energy (pulses of light or energy) advantageously results in rapid heating of the only the target area, while the one or more adjacent areas of the contact are not heated to reflow temperature or to temperatures that cause unwanted material changes. This results due to the short, pulsed nature of the energy that permits only local heating since there is not sufficient time for heat to be transferred to the one or more adjacent areas. In other words, the quick burst of energy causes very localized heating at the target area but does not result in heat transfer to other areas. This is a great improvement over conventional reflow techniques where the entire contact is exposed to reflow temperatures and thus, some areas are undesirably exposed to heat which can result in damage to the properties of the material (e.g., the metal plating) at these sites.

While exemplary drawings and specific embodiments of the present invention have been described and illustrated, it is to be understood that the scope of the present invention is not to be limited to the particular embodiments discussed. Thus, the embodiments shall be regarded as illustrative rather than restrictive, and it should be understood that variations may be made in those embodiments by workers skilled in the art without departing from the scope of the present invention as set forth in the claims that follow, and equivalents thereof. In addition, the features of the different claims set forth below may be combined in various ways in further accordance with the present invention.

What is claimed is:

1. A method of reflowing a metal plated target area of a conductive contact, comprising the steps of:
providing a localized heat source;
positioning the contact relative to the localized heat source such that energy produced by the localized heat source is focused on the plated target area of the conductive contact; and
operating the localized heat source so as to focus emitted energy on the target area such that the metal plating in the target area is heated to a reflow temperature which is greater than a melting temperature of the metal plating so as to cause reflow of the metal plating, wherein the reflow is confined to the target area, while one or more adjacent areas are shielded from being heated to the reflow temperature.

2. The method of claim 1, wherein the metal plating comprises a pure tin plating.

3. The method of claim 1, wherein the metal plating comprises a plating formed of an alloy of tin and another metal.

4. The method of claim 1, wherein the localized heat source is selected from the group consisting of a laser, a xenon light, a focused UV light source, and a focused IR source.

5. The method of claim 1, wherein the focused energy is in the form of a discrete, well defined beam or column of energy or light that is focused on the target area.

6. The method of claim 1, wherein the localized heat source comprises a laser selected from the group consisting of: a diode laser, a CO₂ laser, YAG laser and a pulsed YAG laser.

7. The method of claim 1, wherein the conductive contact comprises a solder tail type contact, with the metal plated target area being a solder tail section of the contact.

8. The method of claim 1, wherein at least one adjacent area has a plated surface.

9. The method of claim 1, wherein the at least one adjacent area that has a plated surface is plated with a second material different than the plated material at the target area.

10. The method of claim 9, wherein the reflow temperature of the second material is less than the reflow temperature of the plated material at the target area.

11. The method of claim 1, wherein the reflow temperature is a temperature at least 10° C., greater than the melting temperature.

12. The method of claim 1, wherein the reflow temperature is a temperature greater than 232° C.,

13. The method of claim 1, wherein the reflow temperature is a temperature between about 282° C., and about 312° C.,

14. The method of claim 1, wherein the conductive contact has a body portion adjacent the target area that is formed of a precious metal and is shielded from the reflow temperatures due to the focusing of the heat on the target area so as to prevent oxidation of the precious metal.

15. The method of claim 1, wherein the metal plated target area is free of lead.

16. The method of claim 1, wherein the adjacent areas are free of oxidation caused by exposure to reflow temperatures.

17. The method of claim 1, wherein the reflowed target areas are free of whiskers.

18. The method of claim 1, wherein the localized heat source is configured to generate short pulsed bursts of energy that are focused on the target area so as to heat and reflow only the metal plating at the target area.

19. A conductive contact for use in electrically connecting one component to another comprising:
a body having a first section and a second section, the first section being a fused metal plating formed by a reflow of the metal plating induced by exposure to concentrated energy emitted by a localized heat source, the second section being free of oxidation and free of material property changes caused by exposure to reflow temperatures generated during the induced reflow.

20. A conductive contact, for use in electrically connecting one component to another component, made in accordance with the method of claim 1.

21. A method of mitigating formation of whiskers in a pure tin plated surface associated with a substrate comprising the steps of:
providing a localized heat source;
positioning the substrate relative to the localized heat source such that a energy emitted by the localized heat source is focused on the tin plated surface; and
operating the localized heat source and focusing the emitted energy on the tin plated surface such that the tin plated surface is heated to a reflow temperature which is greater than a melting temperature of the tin plating so as to cause reflow of the tin plating.

22. The method of claim 21, wherein the substrate comprises a conductive contact for use in electrically connecting one component to another, the substrate having at least one second surface adjacent the tin plated surface, wherein the reflow of the tin plating is confined to an area of the tin plated surface, while the second surface is shielded from being heated to the reflow temperature.

23. The method of claim 21, wherein the conductive contact comprises a solder tail type contact, with the tin plated surface comprising a solder tail section of the contact.

24. The method of claim 21, wherein the localized heat source is selected from the group consisting of a laser, a xenon light, a focused UV light source, and a focused IR source.

25. The method of claim 21, wherein the focused energy is in the form of a discrete, well defined beam or column of energy or light that is focused on the target area.

26. The method of claim 21, wherein the localized heat source comprises a laser selected from the group consisting of: a diode laser, a CO₂ laser, YAG laser and a pulsed YAG laser.

27. The method of claim 21, wherein the reflow temperature is a temperature at least 10° C., greater than the melting temperature.

28. The method of claim 21, wherein the reflow temperature is a temperature between about 282° C., and about 312° C.,

29. The method of claim 21, wherein the step of operating the localized heat source and focusing the emitted energy on the tin plated surface is performed so that at least substantially all of the tin plated surface is within the inner boundaries of the emitted energy so as to result in reflow of at least substantially all of the tin plating.

30. The method of claim 21, wherein the localized heat source is configured to generate short pulsed bursts of energy that are focused on the target area so as to heat and reflow only the metal plating at the target area.
